(19) United States
(12) Patent Application Publication
(10) Pub. No.: US 2009/0175036 A1
(43) Pub. Date: Jul. 9, 2009

(54) Light fixture

(76) Inventors: Leni Schwendinger, New York, NY (US); Courtney Hewitt, New York, NY (US); Gregory J. Subisak, Gahanna, OH (US); Raymond C. Rice, New Philadelphia, OH (US); Mitchell F. Bruns, Heath, OH (US)

Correspondence Address: FISH & RICHARDSON P.C., P.O. BOX 1022, MINNEAPOLIS, MN, 55440-1022, US

(21) Appl. No.: 12/317,398

(22) Filed: Dec. 22, 2008

Related U.S. Application Data
(60) Provisional application No. 61/016,384, filed on Dec. 21, 2007.

(51) Int. Cl. F21V 1/00; F21V 21/00

(52) U.S. Cl. 362/235; 362/249.01

(57) ABSTRACT

In some implementations, a light fixture comprises an inner spherical member, a plurality of light emitting elements disposed on the inner spherical member and an outer spherical member substantially encompassing the inner spherical member. In some implementations, the inner and outer spherical members are coupled to a base. In some implementations, the inner and/or outer spherical members are substantially spherical and include a truncated bottom portion that mounts to a base. In some implementations, the outer sphere comprises substantially transparent regions arranged to substantially align with the light elements. In some implementations, the outer sphere is substantially translucent and/or opaque except for the transparent regions.

### CLAIM OF PRIORITY

This application claims priority under 35 U.S.C. § 119(e) to U.S. Provisional Patent Application Ser. No. 61/016,384, filed Dec. 21, 2007, which is incorporated by reference in its entirety.

### TECHNICAL FIELD

This disclosure relates to a light fixture.

### BACKGROUND

Lamps and light sources typically generate heat. Typically, heat is allowed to dissipate from the bulb into the air or surrounding environment. For example, an incandescent lamp in a typical desk lighting fixture allows heat to escape into air surrounding the light bulb and lighting fixture. As the light intensity increases, the heat generated typically increases. All-weather lamps or light sources that are sealed are typically sealed such that water or moisture cannot enter the body of the lamp. However, this prevents heat from being released from within the body of the lamp.

One type of sealed light fixture that is used for outdoor fixtures utilizes a mercury vapor lamp source. These fixtures are not particularly energy efficient, and contain poisonous gas. Also, the light emitted by these lights have a blue tint that is considered by some to be aesthetically displeasing.

### SUMMARY

In some implementations, a light fixture comprises an inner spherical member, a plurality of light emitting elements disposed on the inner spherical member and an outer spherical member substantially encompassing the inner spherical member. In some implementations, the inner and outer spherical members are coupled to a base. In some implementations, the inner and/or outer spherical members are substantially spherical and include a truncated bottom portion or collar that mounts to a base. In some implementations, the outer sphere comprises substantially transparent regions arranged to substantially align with the light elements. In some implementations, the outer sphere is substantially translucent and/or opaque except for the transparent regions. In some implementations, the light emitting elements comprise one or more diodes (e.g., light emitting diodes (LEDs)).

The details of one or more implementations are set forth in the accompanying drawings and the description below.

Other features will be apparent from the description and drawings, and from the claims.

### DESCRIPTION OF DRAWINGS

FIG. 1 is an illustration of an implementation of a light fixture.

FIG. 2 is an illustration of an implementation of a light fixture.

FIG. 3 is an illustration of an implementation of a light fixture.

FIG. 4A is a bottom view of an implementation of a light fixture.

FIG. 4B is a bottom view of an implementation of a light fixture.

FIG. 5A is an illustration of an implementation of a light fixture.

FIG. 5B is an illustration of an implementation of a light fixture.

FIG. 6 is an illustration of an implementation of a light fixture.

FIG. 7 is an illustration of an implementation of a light fixture.

FIG. 8A is an illustration of an implementation of a light fixture.

FIGS. 9A-9D are front, back, right and front perspective views of an implementation of a light fixture.

FIG. 10 is an illustration of an implementation of an arrangement of the array of light emitting elements.

FIG. 11 is an illustration of an implementation of an arrangement of the array of light emitting elements and transparent regions.

FIG. 12 is an illustration of an implementation of an arrangement of the array of light emitting elements and transparent regions.

### DETAILED DESCRIPTION

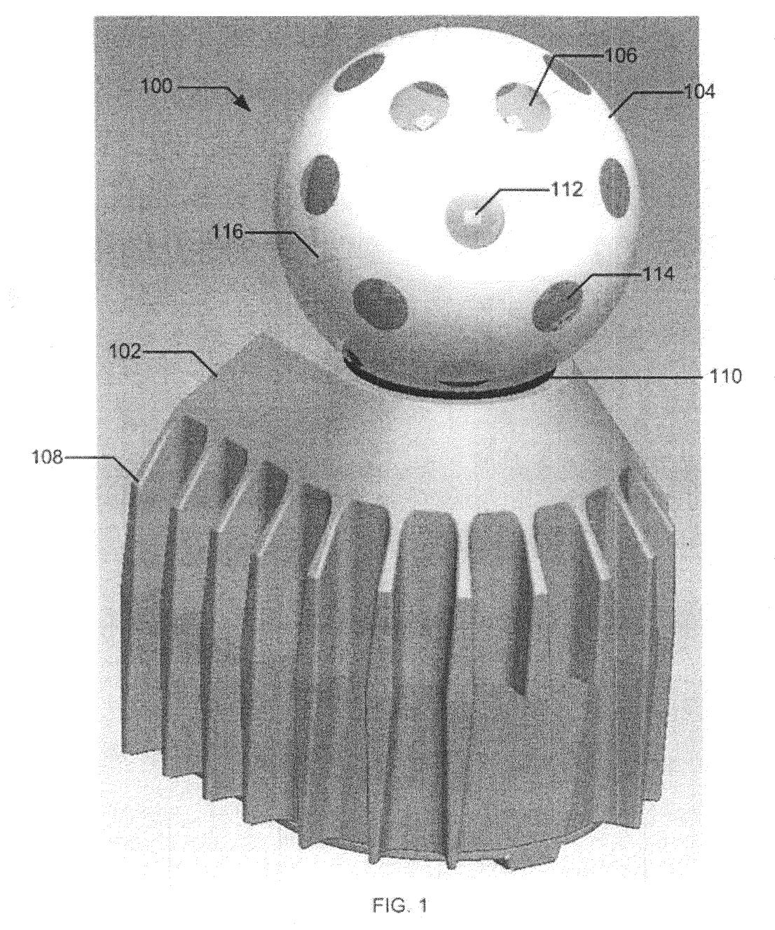

FIG. 1 illustrates an implementation of a light fixture 100 that in some implementations is designed to be viewed from 360 degrees. The light fixture 100 includes a base 102, an outer sphere 104 and an inner sphere 106. The base 102 can be made of any material such as a metal, a ceramic, a glass or other material. The material of the base 102 can be selected such that its thermal conductive properties allow heat to be transferred from the outer sphere 104 and/or the inner sphere 106 (i.e., the base 102 acts as a heat sink). In some implementations, the base 102 is made from aluminum.

The base 102 can include one or more fins 108 protruding from the surface of the base 102 and a connector 110. The fins 108 can be made of the same material as the base 102 or can be made from a different material. The fins 108 can be arranged around the perimeter of the base 102 (e.g., materials with a high thermal conductivity) and can be positioned in any arrangement. For example, the fins 108 can be arranged around the perimeter of the base 102 such that the arrangement of fins 108 maximizes heat transfer or heat dissipation from the base 102. In addition, the fins 108 can have different shapes and can have different sizes. The size and shape of the fins 108 can be chosen to facilitate the heat transfer from the base 102. The base 102 can also include driver circuitry for the light emitting elements 112 (e.g., a lamp ballast or an LED driver).

The connector 110 can be any type of connector that allows the inner sphere 106 and/or the outer sphere 104 to be coupled to the base 102. For example, the connector 110 can be a threaded socket similar to an incandescent light bulb socket. Another example is a connector 110 that is similar to an electrical outlet (i.e., a socket with two areas that allow for a connector to plug into the socket). Another example is a connector 110 that is a combination of the threaded socket and an electrical outlet. The connector 110 can also be used to form an electrical connection between the base 102 and the inner sphere 106. In some implementations, the connector 110 can be a type of connector that allows the inner sphere 106 and the outer sphere 104 to be sealed to the base 102 in a manner that protects the inner sphere 106 and/or the light sources 112 from rain, snow, sleet, and the elements in general (i.e., weather resistant) and/or prevents incursions of water or salt, as an example.

Although light emitting elements 112 (particularly LEDs) are generally robust, the fixture 100 is also robust and can be installed in harsh environments (e.g., outdoors, marine environments, etc.) that are subject to, e.g., the elements. By disposing the light emitting elements 112 in a sealed enclosure, the light fixture 100 requires less maintenance and can endure longer times between the replacement of the light sources 112. This advantage is compounded by the fact that fixture 100 can be installed in locations (e.g., on a suspension bridge cable, at high elevations, etc.) that are costly and dangerous to access. However, the use of a sealed enclosure raises concerns of thermal management of the light emitting elements 112. Generally, light emitting elements 112 (e.g., LEDs) that operate in a higher-temperature environment have a shorter life expectancy than those that operate in a lower-temperature environment. This concern is addressed by utilizing the inner sphere 106 and base 102 to draw heat out of the enclosure formed by the inner and outer spheres. In some implementations, the inner sphere 106 can be divided into two segments to improve the thermal management of the light emitting elements 112. For example, in some implementations, the inner sphere 106 can be vertically divided into two hemispheres to provide a thermal contact surface between each hemisphere and the base 102. This, too, increases the reliability and lifespan of the light emitting elements 112.

The inner sphere 106 is substantially spherical and can include a truncated portion that allows the inner sphere 106 to be mounted on the base 102. Alternatively, the inner sphere 106 can include a connecting member that allows the inner sphere 106 to connect to the connector 110 and/or the outer sphere 104. Additionally, the inner sphere 106 can be coupled to the outer sphere 104. The inner sphere 106 can be coupled to the base 102 such that an electrical connection is formed.

In some implementations, the inner sphere 106 is made from a material chosen for its thermal conduction properties. In some implementations, the inner sphere 106 is made from a metal and/or ceramic material. For example, the inner sphere 106 can be made from a material that has high thermal conductivity such as aluminum. In addition, the inner sphere 106 can be made from a material that has a surface that acts as a reflector to increase the light output efficiency of at least some of the light emitting elements 112, such as aluminum, silver, a material having a silver-like appearance or a material coated with a reflective paint, or to change the visual effect of the light fixture 100.

The inner sphere 106 includes an array of light emitting elements or light sources 112 coupled to the outer surface of the inner sphere 106. The light sources 112 can be any type of light source such as a light emitting diode or other lighting technology. In some implementations, the light sources 112, when implemented using the described techniques, have a lifetime of tens of thousands of hours such that the light sources 112 seldom need replacing.

The light sources 112 are arranged over the surface of the inner sphere 106. As illustrated, the light sources 112 can be arranged in a particular, regular pattern over the surface of the inner sphere 106. In the alternative, the light sources 112 can be arranged in any pattern and is not limited to being arranged in a regular pattern. This arrangement can vary with the implementation. For example, if a greater amount of light or a greater number of visible points of light is desired, more light sources 112 can be employed. In another example, the light sources 112 can be arranged such that one or more light sources 112 are located beneath each of the transparent regions 114 distributed over the surface of the outer sphere 104, which are described below. Also, since the pattern of light sources 112 can contribute to a visual or aesthetic effect, the pattern of light sources 112 can vary with the implementation. For example, the light sources 112 can be arranged such that they are not aligned with the transparent regions 114 to create a visual effect.

In addition, the light sources 112 can be thermally coupled to the surface of the inner sphere 106 using silicon or metal. In some implementations, the light sources 112 can be coupled to the surface of the inner sphere 106 by thermally conductive paste. In other implementations, the light sources 112 can be coupled to the surface of the inner sphere 106 through a metal contact plate that conducts heat away from the light sources 112 to the inner sphere 106.

The inner sphere 106 is coupled to the base 102 through the connector 110 such that the base 102 draws heat away from the light sources 112, inner sphere 106 and/or the connector 110. For example the base 102 can act as a heat sink and allow the heat generated by the array of light sources 112 to be conducted by the inner sphere 106 and dissipated through the base 102 and the fins 108.

The outer sphere 104 is substantially spherical and can have a truncated portion that allows the outer sphere 104 to be mounted on the base 102. Alternatively, the outer sphere 104 can include a connecting member that allows the outer sphere 104 to connect with the connector 110 and/or the inner sphere 106. The outer sphere 104 has a diameter larger than the inner sphere 106 such that the outer sphere 104 substantially surrounds the inner sphere 106. The diameter can be any distance such that the inner sphere 106 and the array of light sources 112 are substantially surrounded by the outer sphere 106. For example, the diameter of the outer sphere 104 can be approximately eight to ten inches. In some implementations, the diameter of the outer sphere 104 is a distance such that a visual effect is created. For example, the diameter of the outer sphere 104 can be chosen such that distance between the inner sphere 106 and the outer sphere 104 (i.e., “the offset”) causes the light sources 112 appear to sparkle. For example, in some implementations, a sparkle effect can be created when the outer sphere 104 has a diameter equal to approximately 6.4 inches and the inner sphere 106 has a diameter equal to approximately 4.95 inches, which results in an offset of 0.725 inches. In other implementations, the diameter of the outer sphere 104 is a distance that facilitates the heat generated by the light sources 112 to be dissipated though the base 102. In some implementations, the offset is chosen such that the light emitted by each of the light sources 112 is matched with a transparent region 114 or with a translucent and/or opaque regions 116.

The outer sphere 104 can be coupled to the inner sphere 106 and/or the base 102 through the connector 110. In some implementations, the outer sphere 104 is coupled to the base 102 such that a seal is formed and the inner sphere 106 is protected from precipitation or other environmental conditions.

The outer sphere 104 can be glass, acrylic or any other material. The outer sphere 104 includes transparent regions 114 (sometimes referred to as holes) distributed over the surface of the outer sphere 104. The transparent regions 114 can be completely transparent or can be substantially transparent. The outer sphere 104 and/or the transparent regions 114 can also be coated such that the coating gives the outer sphere 104 and/or the transparent regions 114 a different lighting effect (e.g., a prism-like coating, application or casting to refract light). In some implementations, the outer sphere 104 and/or the transparent regions 114 can have integral prismatic structures that refract light and provide a different lighting effect. In some implementations, the transparent regions 114 are coated with a light filtering material. In other implementations, at least a portion of the outer sphere 104 is coated with a material that is energized by light. For example, the coating can be a material containing phosphors that radiates visible light upon being energized. Portions of the inner and outer surfaces of the outer sphere 104 and/or the transparent regions 114 can be coated.

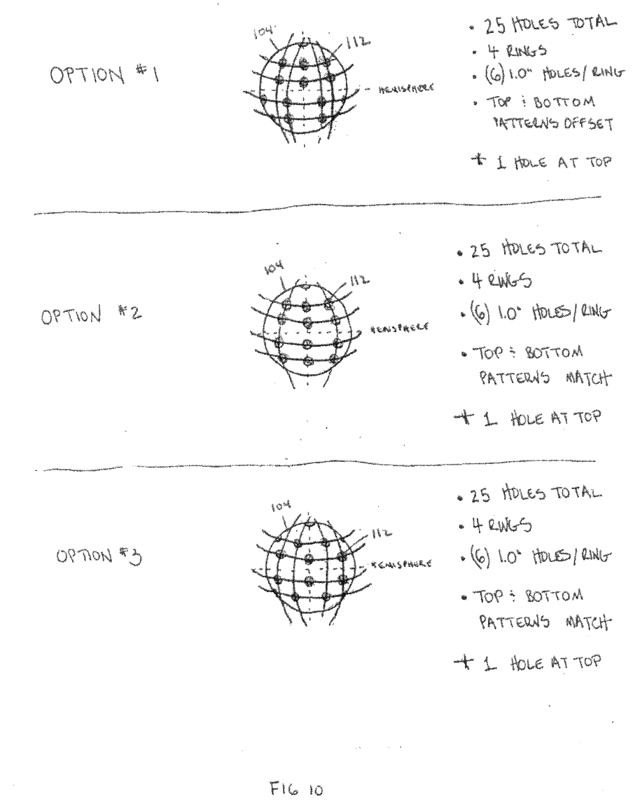

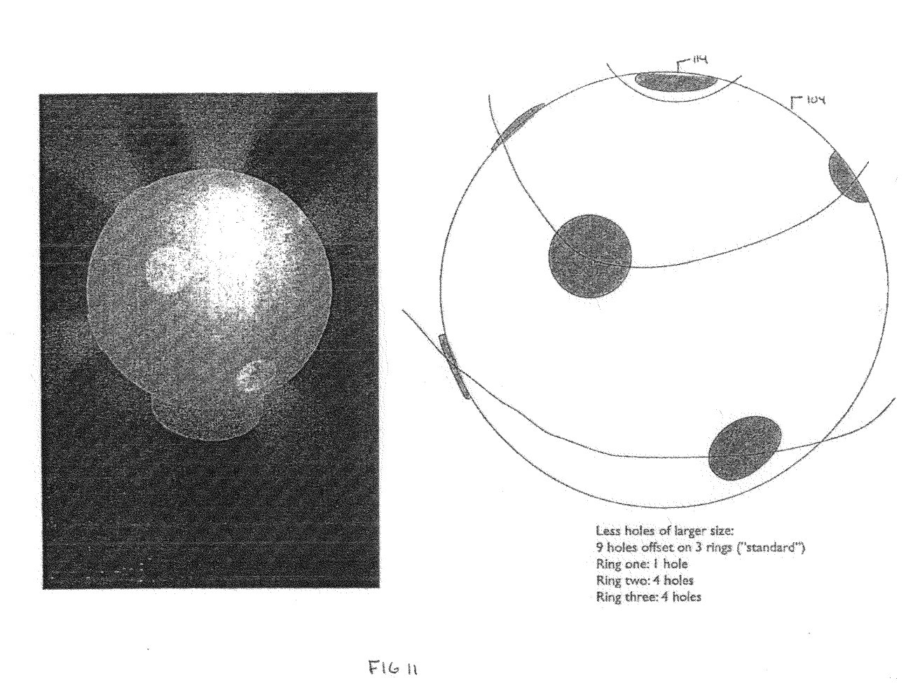

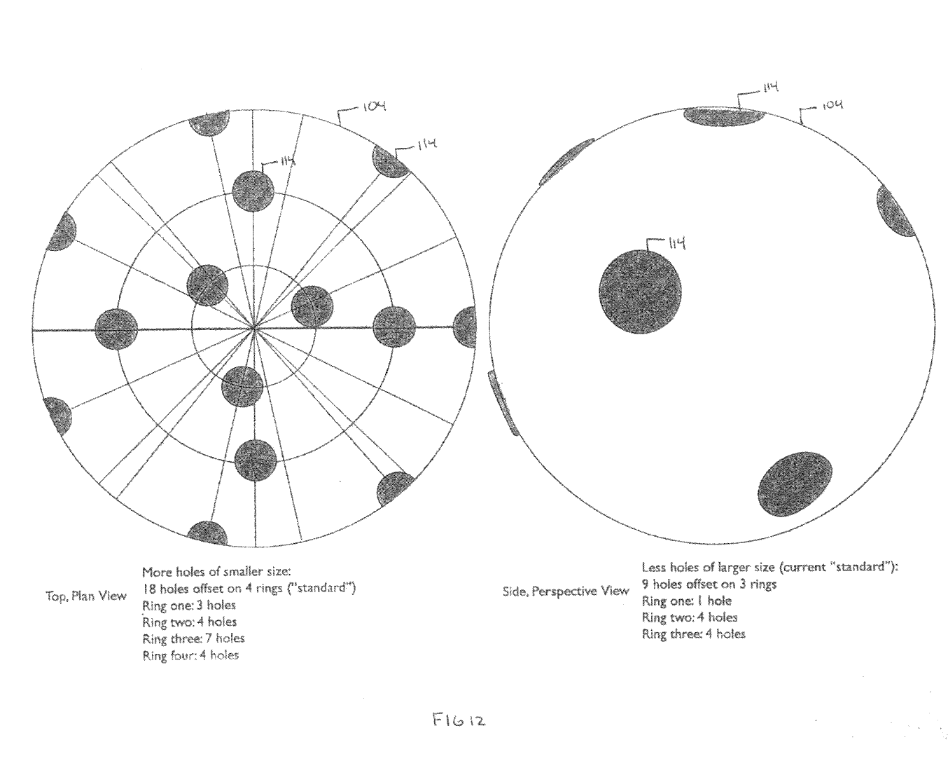

The transparent regions 114 can be any type of shape. For example, the transparent regions 114 can be circular, triangular or can not have a uniform shape (e.g., an amoeba-like shape). The transparent regions 114 can be arranged on the outer sphere 104 in any manner. For example, in some implementations, the transparent regions 114 are arranged on the outer sphere 104 such that the transparent regions 114 are aligned with the array of light sources 112 (i.e., the transparent regions 114 overlap the light sources 112). In other implementations, the transparent regions 114 are arranged on the outer sphere 104 such that the transparent regions 114 are offset from the array of light sources 112 (i.e., the transparent regions 114 do not overlap the light sources 112). The outer sphere 104 can include any number of transparent regions 114. In some implementations, the number of transparent regions 114 equals the number of light sources 112. In some implementations, there are twenty-four transparent regions 114 arranged on the outer sphere 104. For example, FIGS. 1-3 show an implementation of light fixture 100 with twenty-four transparent regions. The transparent regions 114 can be arranged in four rows of transparent regions 114 where each row includes six transparent regions 114. In other implementations, there are twenty-five transparent regions 114 arranged on the outer sphere 104 in a particular pattern. See FIGS. 10-12 for example configurations of the transparent regions 114.

The outer sphere 104 also can include translucent and/or opaque regions 116 distributed over the surface of the outer sphere 104. The translucent and/or opaque regions 116 can be similar to diffusion glass or frosted glass (i.e., glass that is not clear but allows for some light to pass). In some implementations, the use of diffusion glass causes the light fixture 100 and/or the translucent and/or opaque regions 116 to glow like a pearl. In some implementations, the outer sphere 104 consists primarily of the translucent and/or opaque regions 116 except for the transparent regions 114. The translucent and/or opaque regions 116 can be coated similar to the outer sphere 104 and/or the transparent regions 114.

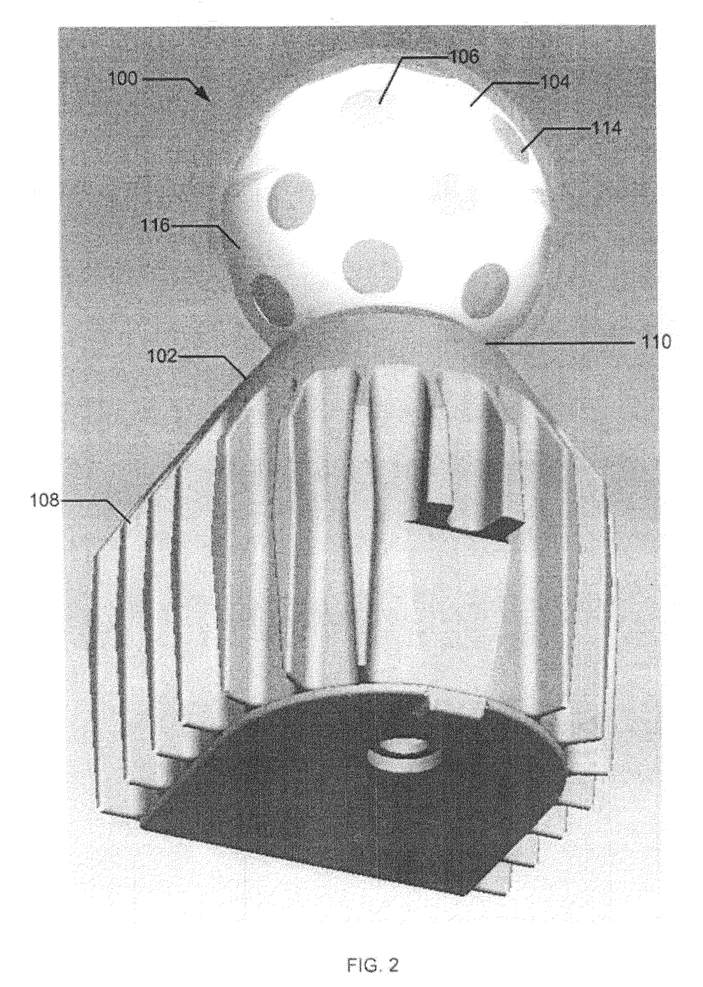

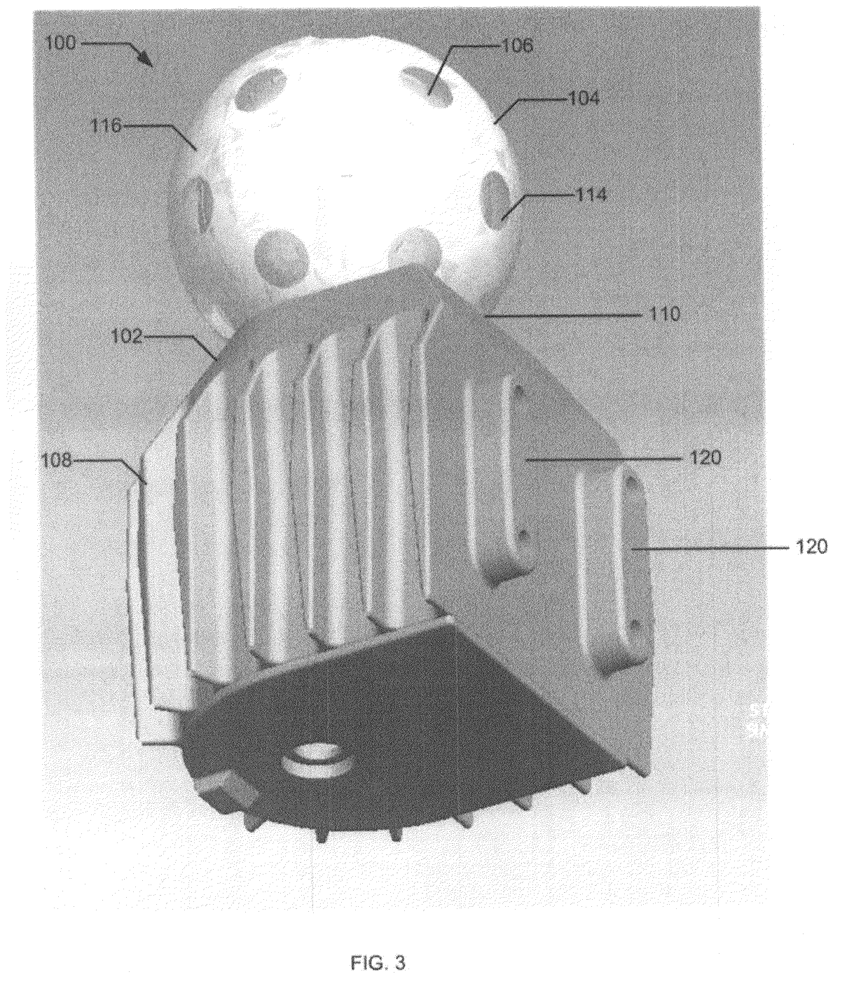

FIGS. 2-9 illustrate additional views of additional implementations of a light fixture. As seen in FIG. 3, the base 102 can also include a bracket portion 120. The bracket portion 120 can be used for mounting the base 102 to another surface. The bracket portion 120 can be any type of bracket. For example, the bracket portion 120 can be configured to use screws to mount the base 102 to another surface or can be configured to connect to a mounting plate.

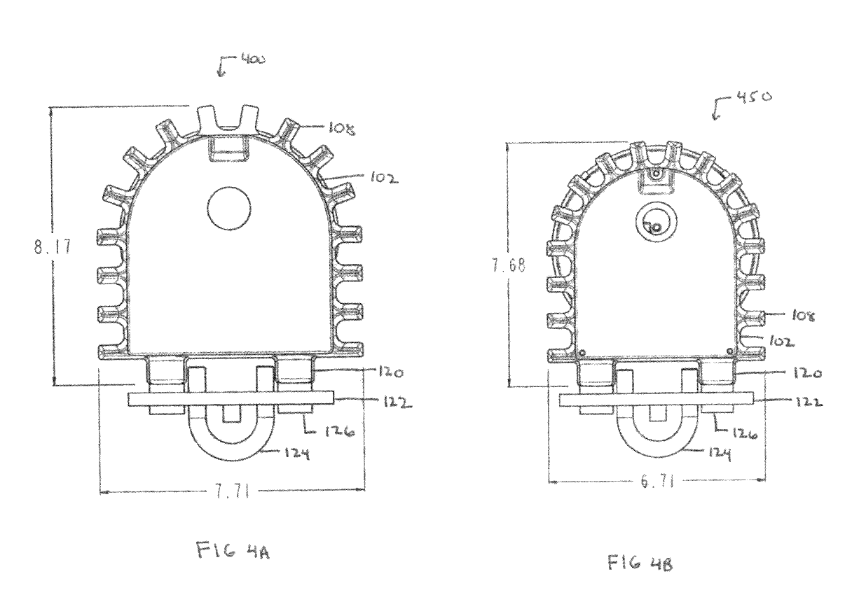

FIGS. 4A and 4B illustrate bottom views of two implementations of light fixture 100. Light fixtures 400 and 450 are similar in relevant aspects to light fixture 100. As seen in FIG. 4A, light fixture 400 includes a mounting plate 122 that is connected to the bracket portion 120. The mounting plate 122 can be made of the same material as the base 102 or can be made from a different material. The mounting plate 122 includes one or more loops 124 that can be used to affix the light fixture 400 to a pole, a post, a suspension bridge cable or other vertical member. The mounting plate 122 is connected to the bracket portion 120 by one or more fasteners 126. The fasteners 126 can be similar to a bolt, a screw, or other fastening device.

The size of the light fixture can vary depending on the implementation. For example, light fixture 400 includes a base 102 that is 7.71 inches wide and 8.17 inches deep. In another example shown in FIG. 4B, the light fixture 450 includes a base 102 that is 6.71 inches wide and 7.68 inches deep.

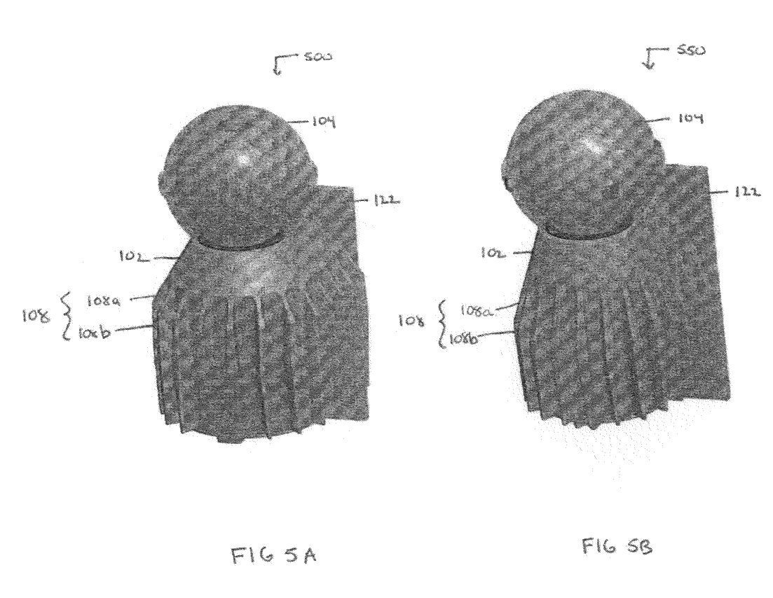

FIGS. 5A and 5B illustrate two example implementations of light fixture 100. As described above, the fins 108 can have different shapes. For example, light fixtures 500 and 550 includes fins 108 that have a upper portion 108a and a lower portion 108b. As seen in FIG. 5A, the length of the upper portion 108a is shorter than the length of the lower portion 108b. On the other hand, light fixture 550 includes fins 108 with upper portions 108a and lower portions 108b that are approximately equal in length.

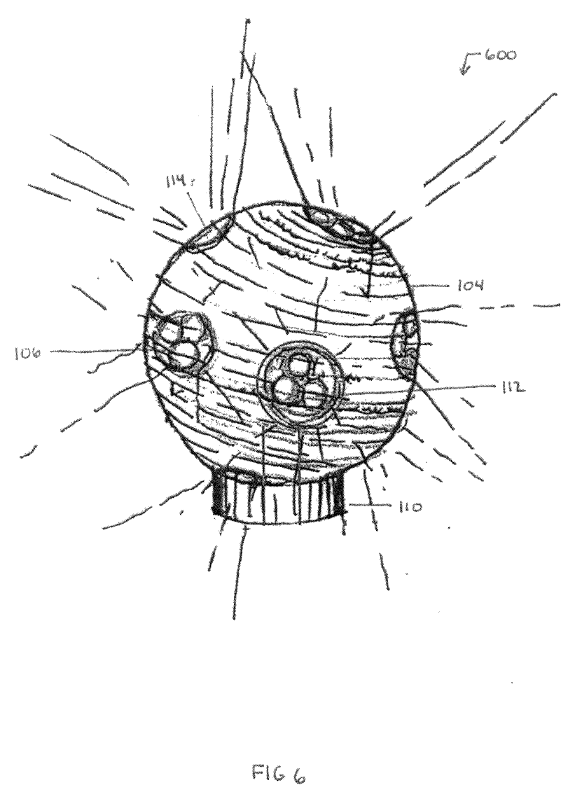

FIG. 6 illustrates an example implementation of light fixture 100. As described above, the light sources 112 can be arranged such that one or more light sources 112 are located beneath the transparent regions 114. For example, light fixture 600 includes an array of light sources 112 that are arranged on the surface of the inner sphere 106 such that the light sources 112 are clustered together in groups of three, which can increase the amount of light output by the light fixture 600, and the transparent regions 112 are arranged such that each transparent region 114 is aligned with each cluster of three light sources 112. In some implementations, the light sources 112 can be arranged such that each transparent region 114 is aligned with a single light source 112.

In addition, as described above, the outer sphere 104 can have a diameter of any size. For example, light fixture 600 includes an outer sphere 104 having a diameter of eight to ten inches.

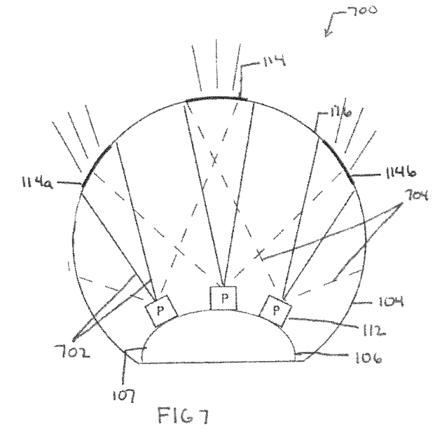

FIG. 7 illustrates an example implementation of light fixture 100. Light fixture 700 includes an outer sphere 104 and inner sphere 106. The outer sphere 104 includes transparent regions 114 that can be made from materials that sparkle similar to a diamond when light passes through or shines on the transparent regions 114. For example, the material can be clear glass, a fluted glass or a prismatic glass. The outer sphere 104 also includes translucent and/or opaque regions 116 that are made from materials that allow the outer sphere 104 appear to glow when the light sources 112 are turned ON. For example, the translucent and/or opaque regions 116 can be made from diffusion glass, a frosted glass or a glass with integral prismatic structure. In addition, the outer sphere 104 can also include transparent regions 114a that are coated with a light filtering material. For example, the transparent region 114a can be coated with a light filtering material that changes the color of the light emitted from the light fixture 700. The outer sphere 104 can also include transparent regions 114b that are coated with a material that refracts light. For example, the transparent region 114b can be coated with a prism-like material.

The inner sphere 106 includes light sources 112 that can emit a directed beam of light 702 and a wide field of light 704. The light sources 112 are arranged on the surface of the inner sphere 106 such that the directed beam of light 702 is focused primarily on the transparent regions 114. In addition, the inner sphere 106 and the outer sphere 104 are arranged to facilitate the directed beam of light 702 to be focused primarily on the transparent regions 114. The wide field of light 104 covers a larger area of the inner surface of the outer sphere 104 and passes through the translucent and/or opaque regions 116 such that the light fixture 700 appears to glow when the light sources 112 are turned ON. For example, the light fixture 700 can have a pearl-like glow.

In addition, the inner sphere 106 can be made from a material that has a surface 107 that acts as a reflector to increase the light output efficiency of at least some of the light emitting elements 112, such as aluminum, silver or a material coated with a reflective paint, or to change the visual effect of the light fixture 700.

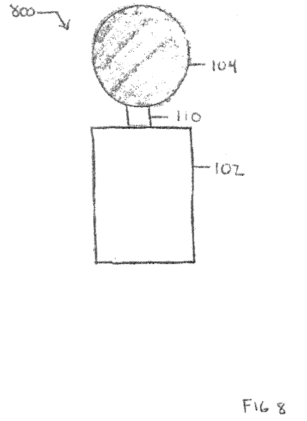

FIG. 8 illustrates an implementation of light fixture 100. As described above, the connector 110 can be any type of connector that allows the inner sphere 106 and/or the outer sphere 104 to be coupled to the base 102. As seen in FIG. 8, light fixture 800 includes a connector 110 that is similar to a post or collar. The collar-connector 110 forms an electrical connection between the base 102 and the light sources 112 and can form a weather-proof seal to protect the light sources and/or the inner sphere.

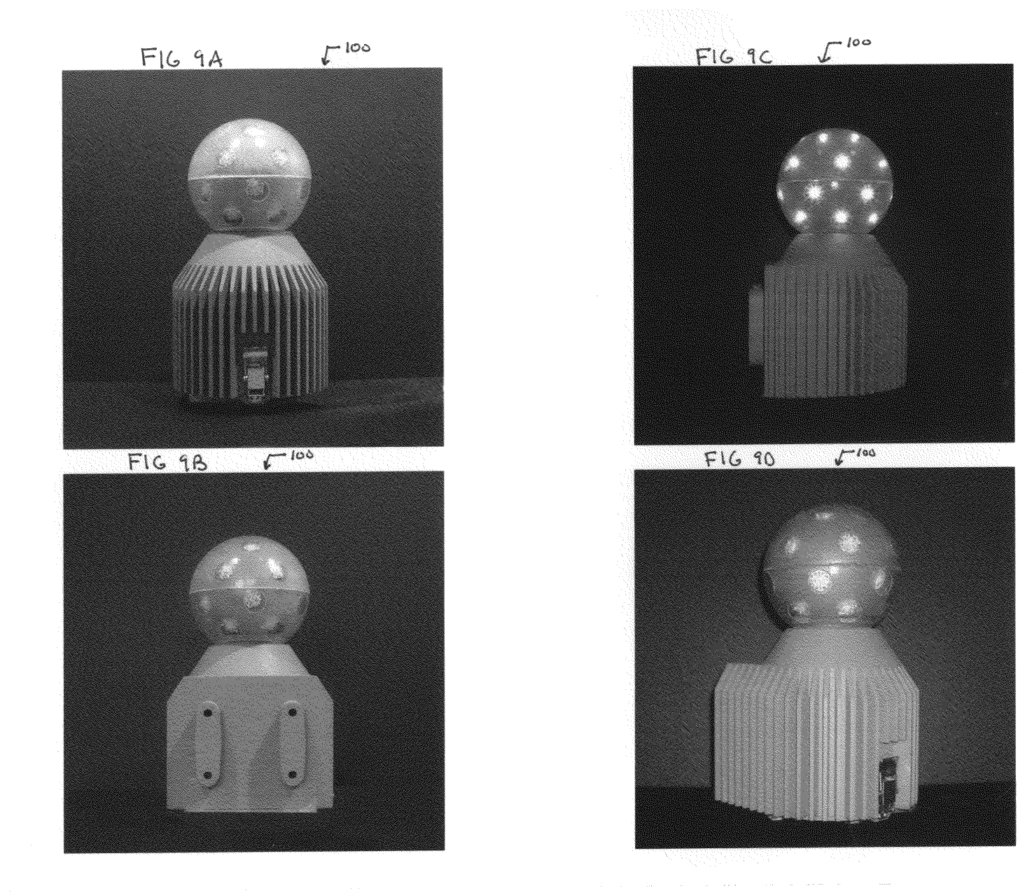

FIGS. 9A-9C illustrate a front, back and right view of a light fixture 100, respectively. FIG. 9D illustrates a front perspective view of the light fixture 100. FIG. 9C illustrates an example of light fixture 100 with the light sources turned ON and a sparkle effect created by the transparent regions and/or the outer sphere.

FIGS. 10-12 illustrate implementations of the array of the light emitting elements and the corresponding transparent regions 114, which are referred to as holes.

There is a particular distance between the light sources 112 and the outer sphere 104. While this distance can vary somewhat from individual light source to individual light source, given that items 104 and 106 are both spherical, in some implementations the distance is substantially constant. In some implementations, the distance from a light source to the outer sphere 104 can vary from light source to light source. One advantage of the distance between the light source and the outer sphere is that it creates a visual effect (a “sparkle” effect) when a viewer's perspective changes with respect to the light. Thus, if the light is implemented on a roadway, persons in automobiles will experience an aesthetically pleasing visual effect as they pass by. In addition, if the light fixture 100 is implemented on a building top, pedestrians and airplane passengers will experience the sparkling effect. This, combined with LEDs that are capable of producing various colors of light (e.g., white, blue, etc.), can result in implementations that provide unique visual effect.

Aesthetic Features

In one implementation, the light fixture 100 is implemented as “necklace” lighting that is typically used to illuminate various structures of suspension bridges. In one implementation, the light fixture 100 is reminiscent of a pearl studded with diamonds.

To evaluate the aesthetics of a light fixture 100, one can consider: (1) the concept and psychological associations; (2) the form of the light fixture such as the shape and dimensional proportions; and (3) the visual effect and color consistencies at close distances and at far distances.

In one implementation, the light fixture 100 provides the following visual characteristics: (1) a light fixture that fits neatly into the concept of “necklace” lighting and provides a pleasurable mental connection; (2) an elegant, compact form with balanced proportions (e.g., a sphere within a sphere); and (3) sparkling light easily viewed from 360-degrees with good contrast ratio and excellent white-light color consistency.

Advantages

As described above, numerous advantages can be obtained from the light fixture (e.g., light fixture 100). In some implementations, the light sources 112 are protected from environmental conditions because the connector 110 seals the outer sphere 104 to the base 102. This allows the light sources 112 to have a longer lifespan and reduces the time between maintenance. As described above, this will reduce the cost of maintenance because frequent maintenance will not be required.

However, operating the light emitting elements 112 in a sealed environment raises thermal management issues. These issues are overcome by yet additional advantageous features. For example, in some implementations, the base 102 and inner sphere 106 are made from thermal conductive materials to allow heat to be transferred from the light emitting elements 112 to the inner sphere 106 and to the base 102, which in turn dissipates heat to the ambient environment. In addition, the thermal conductivity can be further increased by the use of one or more fins 108 protruding from the base 102. By managing the heat of the environment in which they operate, the life span and reliability of the light sources 112 can be increased. This can result in the light fixture 100 operating longer times between maintenance and/or replacement of the light sources 112. Because the light fixture 100 can be used on bridges, active roadways, in areas that are not easily accessible or in areas that are hazardous to humans, increasing the life span of the light sources 112 and/or the time between maintenance substantially reduces the cost of maintenance, and therefore, the total cost of the fixture.

In some implementations, the light sources 112 are arranged on the surface of the inner sphere 106 to create aesthetic features. The aesthetic features can be changed by using different light sources 112, changing the arrangement of the light sources 112, changing the diameter of the outer sphere 104, changing the positioning of the transparent regions 114 and changing the material and/or coating of the transparent regions 114. As described above, visual effects can be created by changing the offset between the inner sphere 106 and the outer sphere 104. The offset can be chosen such that the various visual effects such as sparkling can be achieved.

A number of implementations have been described. Nevertheless, various modifications may be made without departing from the spirit and scope of the invention. For example, the outer sphere 104 may be entirely transparent. Another example is a light fixture 100 that is used in various environments such as indoors or in other out-door environments (e.g., non-bridge environments). Accordingly, other implementations are within the scope of the following claims.

What is claimed is:

1. A light fixture comprising:
an inner substantially spherical member;
a plurality of light emitting elements disposed on the inner substantially spherical member and thermally coupled thereto; and
an outer substantially spherical member substantially encompassing the inner substantially spherical member,
wherein the inner and outer substantially spherical members are coupled to a base;
wherein the base is configured to conduct heat away from the inner substantially spherical member; and
wherein the outer substantially spherical member and the base form a substantially sealed structure that encompasses the inner substantially spherical member and is weather resistant.

2. The light fixture of claim 1 wherein the base is formed from at least one material with high thermal conductivity.

3. The light fixture of claim 1 wherein the base is formed from aluminum.

4. The light fixture of claim 1 wherein the base comprises one or more fins protruding from the base.

5. The light fixture of claim 4 wherein the one or more fins are configured to conduct heat away from the inner substantially spherical member.

6. The light fixture of claim 4 wherein the one or more fins are formed from at least one material with high thermal conductivity.

7. The light fixture of claim 5 wherein the one or more fins are formed from aluminum.

8. The light fixture of claim 1 wherein at least one of the inner and outer substantially spherical members includes a truncated bottom portion that mounts to the base.

9. The light fixture of claim 1 wherein the outer substantially spherical member comprises a plurality of substantially transparent regions arranged such that each of the substantially transparent regions overlap one of the light emitting elements.

10. The light fixture of claim 9 wherein the regions of the outer substantially spherical member aside from the substantially transparent regions are substantially translucent and/or opaque.

11. The light fixture of claim 9 wherein the substantially transparent regions are coated with a light filtering material.

12. The light fixture of claim 9 wherein the substantially transparent regions are coated with a material to refract light.

13. The light fixture of claim 1 wherein the light emitting elements comprise light emitting diodes.

14. The light fixture of claim 1 wherein the base comprises driver circuitry to drive the light emitting elements.

15. The light fixture of claim 1 wherein the outer substantially spherical member has a diameter of eight to ten inches.

16. The light fixture of claim 1 wherein the outer substantially spherical member has a diameter of about 6.4 inches and the inner substantially spherical member has a diameter of about 4.95 inches.

17. The light fixture of claim 1 wherein the inner substantially spherical member has a radius that is about 0.725 inches smaller than a radius of the outer substantially spherical member.

18. The light fixture of claim 1 further comprising a bracket portion configured to connect to a mounting plate by one or more fasteners, wherein the mounting plate comprises one or more loops configured to connect to a vertical member.

19. The light fixture of claim 18 further comprising:
a mounting plate, wherein the mounting plate comprises one or more loops configured to connect to a vertical member and
one or more fasteners configured to connect the mounting plate to the bracket portion.

20. The light fixture of claim 19 wherein the one or more loops is configured to connect to a suspension bridge cable.

21. The light fixture of claim 1 wherein the outer substantially spherical member comprises a plurality of substantially transparent regions arranged such that each of the substantially transparent regions are arranged to be offset from each of the light emitting elements.

22. The light fixture of claim 1 wherein the outer substantially spherical member comprises a plurality of substantially transparent regions arranged to overlap a plurality of light emitting elements.

23. The light fixture of claim 14 further comprising a connector configured to connect the inner substantially spherical member to the base and electrically connect the light emitting elements to the driver circuitry.

24. The light fixture of claim 1 wherein at least the outer surface of the inner substantially spherical member is formed from a reflective material.

25. The light fixture of claim 24 wherein the inner substantially spherical member is formed from materials with high thermal conductivity.

26. The light fixture of claim 1 wherein the inner substantially spherical member is aluminum.

27. The light fixture of claim 1 wherein the inner substantially spherical member and the base are aluminum.

28. The light fixture of claim 1 wherein the outer substantially spherical member comprises a plurality of substantially transparent regions arranged on the outer substantially spherical member in four rows, wherein each row comprises six substantially transparent regions.

29. The light fixture of claim 9 wherein the inner substantially spherical member and the outer substantially spherical member are arranged such that each of the plurality of light emitting elements emit light primarily on the substantially transparent regions.

30. The light fixture of claim 9 wherein the inner substantially spherical member and the outer substantially spherical member are arranged such that each of the plurality of light emitting elements emit light primarily on the substantially transparent regions.

31. The light fixture of claim 9 wherein the inner substantially spherical member and the outer substantially spherical member are arranged such that each of the plurality of light emitting elements emit a beam of light on the substantially transparent regions and emit a field of light on the substantially translucent and/or opaque regions.

32. The light fixture of claim 1 wherein the inner substantially spherical member comprise two hemispheres connected to the base.

33. The light fixture of claim 9 wherein the substantially transparent regions comprise a material having a prismatic structure, wherein the prismatic structure are configured to refract light.

34. The light fixture of claim 1 wherein the outer substantially spherical member comprises a material having a prismatic structure, wherein the prismatic structure is configured to refract light.
